(19) United States
(12) Patent Application Publication
(10) Pub. No.: US 2026/0276609 A1
(43) Pub. Date: Sep. 17, 2026

(54) METHOD AND APPARATUS FOR AUTOMATING LIQUID CHROMATOGRAPHY-MASS SPECTROMETRY

(71) Applicant: SAMSUNG ELECTRONICS CO., LTD., Suwon-si (KR)

(72) Inventors: Seung Min BAEK, Suwon-si (KR); Youngchun KWON, Suwon-si (KR); Dongyeeb SHIN, Suwon-si (KR)

(73) Assignee: SAMSUNG ELECTRONICS CO., LTD., Suwon-si (KR)

(21) Appl. No.: 19/468,601

(22) Filed: Feb. 3, 2026

(30) Foreign Application Priority Data
Feb. 5, 2025 (KR) 10-2025-0014547

(51) Int. Cl. G01N 30/88; G01N 30/86

(52) U.S. Cl. CPC G01N 30/88; G01N 30/8637; G01N 30/8693; G01N 2030/8804

(57) ABSTRACT

A method of automating spectrometry includes obtaining an analysis result by performing an analysis process on spectrometry data, displaying the analysis result on a user interface and receiving a user input through the user interface, identifying at least one of a user intent or an analysis criterion based on the user input, and performing an update to the analysis process based on the at least one of the user intent or the analysis criterion.

### CROSS-REFERENCE TO RELATED APPLICATION

This application claims priority from Korean Patent Application No. 10-2025-0014547, filed on Feb. 5, 2025, in the Korean Intellectual Property Office, the disclosure of which is incorporated herein by reference in its entirety.

### BACKGROUND

### 1. Field

Methods and apparatuses consistent with embodiments of the present disclosure relate to automating liquid chromatography-mass spectrometry (LC-MS).

### 2. Description of the Related Art

Liquid chromatography-mass spectrometry (LC-MS) is an analytical tool for separating and detecting substances. LC-MS enables the measurement of the mass and structural information of each component by using a mass spectrometer after separating components from a mixture through liquid chromatography. LC-MS may be used for the identification and quantitative analysis of substances in various fields, such as chemistry, life sciences, and pharmacy.

General LC-MS data interpretation has been done by users manually analyzing chromatograms and spectra. A user may detect a peak from a chromatogram and may determine the presence of a specific substance based on the mass-to-charge ratio (m/z) information of the peak. In addition, the concentration of the specific substance may be estimated by calculating the area of the peak. This operation relies on the experience and intuition of analysts and may be repetitive and time-consuming.

### SUMMARY

According to an aspect of one or more embodiments, there is provided a method of automating spectrometry including obtaining an analysis result by performing an analysis process on spectrometry data, displaying the analysis result on a user interface and receiving a user input through the user interface, identifying at least one of a user intent or an analysis criterion based on the user input, and performing an update to the analysis process based on the at least one of the user intent or the analysis criterion.

The method of automating spectrometry may further include providing a personalized result to a user based on the updated analysis process.

The obtaining of the analysis result may include performing at least one of peak detection, peak assignment, and peak integration, based on the spectrometry data.

The user interface may display an interface for peak modification.

The identifying of the at least one of the user intent or the analysis criterion may include inferring how a user determines a peak shape.

The identifying of at least one of the user intent and the analysis criterion may include selecting a spectrometry analysis model or updating the spectrometry analysis model.

The method may further include processing peak information in response to a user’s interaction command for at least one of peak detection, peak assignment, and peak integration.

The method may further include analyzing a pattern of a change by comparing data before and after peak modification in response to the user input.

The peak detection may include detecting a valid peak from the spectrometry data.

The peak assignment may include determining whether there is a target substance for a detected peak.

The peak integration may include operating information on each of detected peaks.

The identifying of the at least one of the user intent and the analysis criterion may include obtaining a personalized record based on a history management of the user input and information of a user.

According to another aspect of one or more embodiments, there is provided an electronic device including one or more processors, in which instructions, when performed by the one or more processors, cause the electronic device to obtain an analysis result by performing an analysis process on spectrometry data, display the analysis result on a user interface and receive a user input through the user interface, identify at least one of a user intent or an analysis criterion based on the user input, and perform an update to the analysis process based on the at least one of the user intent or the analysis criterion.

The instructions, when performed by the one or more processors, may cause the electronic device to provide a personalized result for a user based on the updated analysis process.

The instructions, when performed by the one or more processors, may cause the electronic device to perform at least one of peak detection, peak assignment, or peak integration on the spectrometry data.

The user interface may display an interface for peak modification.

The instructions, when performed by the one or more processors, may cause the electronic device to infer how a user determines a peak shape.

The instructions, when performed by the one or more processors, may cause the electronic device to select a spectrometry analysis model or update the spectrometry analysis model by using an interaction handler and a user intent estimator.

According to another aspect of one or more embodiments, there is provided a system of automating spectrometry including a processor configure to: obtain spectrometry data; obtain an analysis result by performing an analysis process on the spectrometry data; a user interface configured to display the analysis result and receive a user input; and wherein the processor is further configured to: identify at least one of a user intent and an analysis criterion based on the user input; and perform an update to the analysis process based on the at least one of the user intent and the analysis criterion.

### BRIEF DESCRIPTION OF THE DRAWINGS

FIG. 1 is a schematic flowchart illustrating a liquid chromatography-mass spectrometry (LC-MS) automation method according to one or more embodiments.

FIG. 2 is a schematic block diagram illustrating an LC-MS automation system according to one or more embodiments.

FIG. 3 is a schematic block diagram illustrating a user intent extraction and personalization system according to one or more embodiments.

FIG. 4 is a diagram illustrating LC-MS data according to one or more embodiments.

FIG. 5 is a schematic diagram illustrating an example of peak determination according to one or more embodiments.

FIGS. 6 and 7 are exemplary diagrams illustrating a user interface according to one or more embodiments.

FIG. 8 is a block diagram schematically illustrating a personalization system including a session manager according to one or more embodiments.

FIG. 9 is a block diagram illustrating an electronic device according to one or more embodiments.

### DETAILED DESCRIPTION

The following detailed structural or functional description is provided as an example only and various alterations and modifications may be made to embodiments. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which the present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The examples may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, embodiments will be described in detail with reference to the accompanying drawings. When describing the examples with reference to the accompanying drawings, like reference numerals refer to like elements and a repeated description related thereto will be omitted.

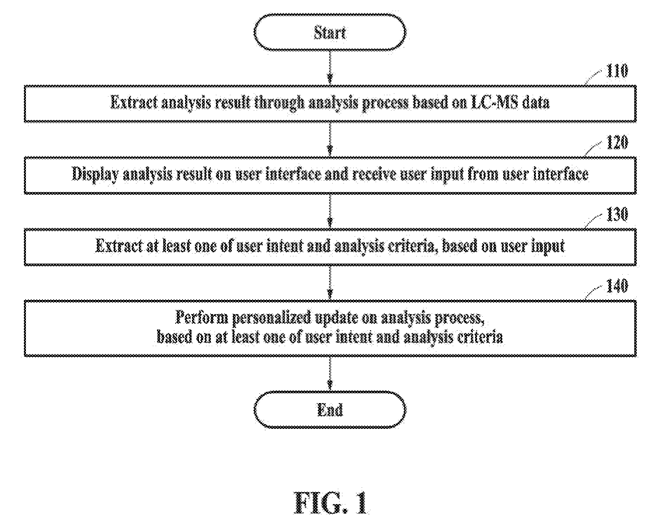

FIG. 1 is a schematic flowchart illustrating a liquid chromatography-mass spectrometry (LC-MS) automation method according to one or more embodiments.

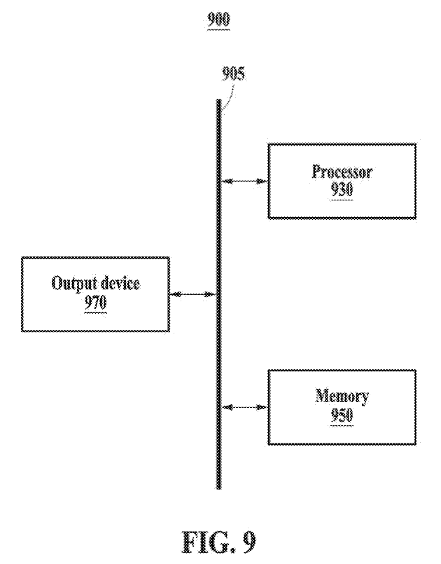

For ease of description, operations 110 to 140 are described as being performed by using an electronic device 900 (e.g., an processor 930) illustrated in FIG. 9. However, operations 110 to 140 may be performed by another suitable electronic device in a suitable system. The electronic device 900 may correspond to, or form part of, a chromatography-mass spectrometry (CMS) system (e.g., a liquid chromatography-mass spectrometer, a gas chromatography-mass spectrometer, and capillary electrophoresis-mass spectrometer, etc.). The CMS system may include or interoperate with a chromatograph (e.g., HPLC or GC unit) for separating compounds, an ion source interface (e.g., electrospray ionization (ESI) or electron ionization (EI)), a mass spectrometer (comprising ion optics, a mass analyzer, and a detector), and a processor for data analysis and visualization.

Furthermore, the operations of FIG. 1 may be performed in the shown order and manner. However, the order of some operations may be changed, or some operations may be omitted, without departing from the spirit and scope of the shown example. The operations illustrated in FIG. 1 may be performed in parallel or simultaneously. Hereinafter, the electronic device 900, according to one or more embodiments, may include an LC-MS automation system 200 (hereinafter, the automated system 200). However, embodiments of the present disclosure are not limited to an LC-MS automation system, and may encompass other CMS automation systems such as a gas CMS system.

The automated system 200 may automate an analysis process based on LC-MS data and may provide a personalized analysis result by reflecting a user’s individual determination criteria (or metrics) and preferences. LC-MS is technology that combines liquid chromatography with mass spectrometry and may be used for qualitative and quantitative analysis of various compounds. A typical LC-MS analysis system may be operated manually because the user needs to intervene with data processing and result provision.

Embodiments to be described below may include automatic processing of data generated during an LC-MS analysis process and personalizing of the analysis process based on data input by a user to generate a precise analysis result customized for the user. The user may visually review analysis data through a graphical user interface (GUI) and may perform operations, such as adding, deleting, merging, or splitting peaks. A user input is recorded by the automated system 200, and analysis criteria and a user intent may be extracted based on data, such as peak shape, size, or location.

The automated system 200, according to one or more embodiments, may update an analysis process or create a new setting by extracting the user intent and reflecting the analysis criteria. The automated system 200 may detect peaks based on the LC-MS data, may determine whether there is a specific substance for each peak, and may calculate the area under a curve including a peak to derive a quantitative result. In this process, modification and determination criteria provided by the user may be reflected in a subsequent analysis model and may be updated as a personalized setting.

The automated system 200, according to one or more embodiments, may reflect the user’s preferences and determinations while being based on automation of a data analysis process. Accordingly, the automated system 200 may increase analysis efficiency and may provide a precise result requested by the user. The automated system 200 may be applied to various LC-MS analysis systems and may improve data processing speed and reliability.

In operation 110, the automated system 200 may extract an analysis result through an analysis process based on the LC-MS data. The automated system 200 may extract at least one of ultraviolet (UV) data and MS data from the LC-MS data by using an LC-MS data extractor 210.

Injecting a sample into the automated system 200 and measuring data may lead to generation of the UV data and the MS data. In response to detecting a peak in a specific time range in the UV data, a mass-to-charge ratio (m/z) and ion intensity in the MS data in that specific time range may be analyzed to identify a peak including a target substance. Then, the concentration of the target substance may be calculated by calculating the area of the peak.

More specifically, the automated system 200, according to one or more embodiments, may perform at least one of peak detection, peak assignment, and peak integration, based on LC-MS data. Peak detection may involve the use of signal-to-noise thresholds or derivative-based algorithms, peak assignment may reference compound libraries or employ predictive models based on a retention time and a mass-to-charge ratio, and peak integration may be executed with correction for co-eluting substances to ensure accurate quantification of the target substance.

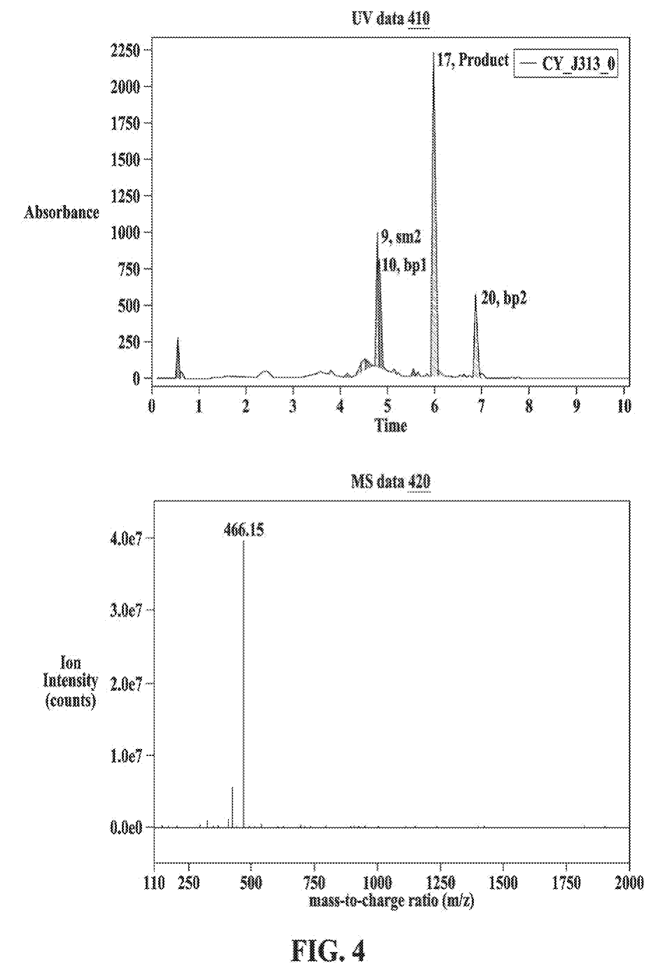

Referring to FIG. 4 together, the LC-MS data may include UV data 410 and MS data 420, which are generated by measuring a sample. The LC-MS data may include the UV data 410 and the MS data 420, generated by measuring a sample. The UV data 410 may indicate a change in absorbance over time, and the MS data 420 may indicate a mass-to-charge ratio (m/z) and ion intensity. This is described with an example in the description of FIG. 4 below.

An LC-MS analyzer 220 included in the automated system 200 may receive such data and may execute an analysis process.

The peak detection may be detecting a valid peak from the LC-MS data. The LC-MS analyzer 220 may detect the valid peak, based on the UV data and the MS data. The peak detection may be identifying a peak in a signal, including at least one of noise peak removing, data processing, peak merging, and peak splitting. For example, a clearly visible signal peak after removing reference noise from the UV data may be identified as a peak. The LC-MS analyzer 220 may secure valid data by calculating start and end points of each peak through the peak detection.

The peak assignment may be determining whether a target substance is included in a detected peak. Once the peak detection is completed, the automated system 200 may determine whether the detected peak is related to the target substance. The LC-MS analyzer 220 may calculate a correlation between the expected mass-to-charge ratio (m/z) data of the target substance and actual MS data. This correlation is expressed by a score, and the LC-MS analyzer 220 may determine that a peak with a high score has a high probability of including the target substance.

The peak integration may be operating information on each of detected peaks. In peak integration, information, such as area, height, start point, and end point, may be operated for each of detected peaks. Peak information may be used to calculate the concentration of a substance or quantify an analysis result. For example, the area of a specific peak may be proportional to the concentration of the target substance.

In operation 120, the automated system 200 may display the analysis result on a user interface 230 and may receive a user input from the user interface 230. The user interface 230 may display an interface for peak modification.

The automated system 200 provides the analysis result visually in the user interface 230 and may receive data input by the user to use the input data in a subsequent analysis step. The user interface 230 may include various interactive elements that support peak modification operations, such as adding, deleting, merging, or splitting peaks.

The automated system 200 may visualize the peak information detected based on the UV data and the MS data. For example, the user interface 230 may express the UV data with a time axis and an absorbance axis to indicate the location and size of each peak. The MS data may show the mass characteristics and concentration of each peak through a mass-to-charge ratio (m/z) and ion intensity. Such visual information may help the user intuitively understand the analysis result and perform a necessary modification.

The user may check the analysis result through the user interface 230 and may perform a modification on a specific peak. For example, the user may enter a user input for separating merged peaks or removing peaks detected incorrectly as noise from the UV data. The user may modify mass-to-charge ratios (m/z) assigned incorrectly or may select peaks needed additionally from the MS data. This user input may be used for the automated system 200 to extract the user intent and personalize and update the analysis process. The user input may be provided directly on a graphical display of UV data (e.g., UV data 410 shown in FIG. 4) using various input methods, such as touch gestures, mouse clicks or dragging actions, or by typing through a virtual or physical keyboard.

For example, the user may determine that a peak 17 in the UV data has not been correctly detected and initiate a peak merging operation. The automated system 200 may receive this user input and may update the position, size, and area data of merged peaks to reflect the updated data in a subsequent analysis step. Accordingly, the user interface 230 not only displays analytical results but also enables dynamic modification of analysis parameters and criteria through direct user interaction, thereby supporting real-time updates to the system's data processing logic.

In operation 130, the automated system 200 may extract at least one of the user intent and the analysis criteria, based on the user input.

The automated system 200, according to one or more embodiments, may infer the user’s interpretation or decision-making approach regarding a peak shape. The user may interact with the user interface 230 to perform operations, such as adding, deleting, merging, or separating peaks. The automated system 200 may analyze these interactions to identify the user intent and the analysis criteria.

The automated system 200, according to one or more embodiments, may include an interaction handler 241 and a user intent estimator 242. The interaction handler 241 and the user intent estimator 242 may enable the automated system 200 to select or update an LC-MS analysis model dynamically, based on user interactions and inferred user intent.

The interaction handler 241 may manage peak-related data (also referred to as peak information) in response to a user interaction command pertaining to at least one of peak detection, peak assignment, and peak integration. The interaction handler 241 may interpret user input actions, such as selecting, deleting, merging, or adjusting peaks, and transform these user input actions into structured input data. For example, if the user deletes a specific peak, the interaction handler 241 may record peak characteristics such as location, area, start point (e.g., start time), and end point (e.g., end time), and may generate base data for estimating a reason for the deletion.

The user intent estimator 242 may analyze changes (e.g., a pattern of changes) introduced through user interactions by pre- and post-modification peak data in response to the user input. For example, when the user merges two adjacent peaks in the UV data, the user intent estimator 242 may analyze the resulting peak's altered shape and dimensions to infer the user’s interpretation criteria. These inferred criteria may include parameters such as a peak-to-peak distance, a height difference (e.g., relative peak height), or a baseline processing method (e.g., a baseline correction method).

In addition, the automated system 200 may update the LC-MS analysis model or select a new model, based on the user intent. For example, when the user repeatedly performs peak merging operations on a specific type of peak, the automated system 200 may set new automatic merging criteria for tailed to the specific type of peak. These user criteria may be applied to various analysis steps, such as peak detection, peak assignment, and peak integration.

For example, if the user manually merges peaks 17 and 18 in the UV data, the automated system 200 may analyze this user input to extract merging criteria based on parameters such as a distance between the two peaks (e.g., an inter-peak distance), a relative peak height, and a baseline shape (e.g., the shape of the baseline between the peaks). These criteria may be applied for automatic merging in a similar or the same data.

In operation 140, the automated system 200 may perform a personalized update on the analysis process, based on at least one of the user intent and the analysis criteria.

The automated system 200, according to one or more embodiments, may provide a personalized result for the user, based on the updated analysis process.

The automated system 200 may reflect the determination criteria and intent inferred through the user input in the analysis process. For example, when the user has repeatedly performed a command to merge adjacent peaks, the automated system 200 may automate the merging in similar situations by reflecting corresponding criteria (e.g., a distance between the peaks and a relative height difference) automatically in the LC-MS analyzer 220.

The automated system 200 may personalize the peak detection of the LC-MS analyzer 220. The automated system 200 may update the noise filtering, peak range adjustment, merging, and separation criteria of a peak detection algorithm, based on the user input. For example, when the user redefines peak separation criteria, the automated system 200 may apply the criteria to generate a new peak detection result.

The automated system 200 may personalize the peak assignment of the LC-MS analyzer 220. The automated system 200 may modify the criteria used in the peak assignment according to the user intent. For example, when the user assigns a specific peak as a major product and another peak as a by-product, the automated system 200 may update criteria for a peak assignment model, based on the assignment.

The automated system 200 may personalize the peak integration of the LC-MS analyzer 220. The automated system 200 may modify a baseline setting, an area calculation method, and peak integration criteria in the peak integration according to the user input. For example, when the user sets a new baseline for a specific peak, the automated system 200 may update a peak area calculation result by reflecting the setting.

The personalized result for the user generated through the updated analysis process may be displayed through the user interface 230. The user may review the displayed result and may provide additional input as needed. For example, when some peaks have been processed differently from the intent in the updated analysis result, the user may input an additional modification command for those peaks.

For example, while analyzing the LC-MS data, it may be assumed that the user merges the peaks 17 and 18 in the UV data and deletes a peak 20.

The automated system 200 may update the peak detection criteria of an analysis model, based on the user’s merging and deleting commands. The updated criteria may then be applied automatically to a similar or the same dataset. The automated system 200 may generate a new analysis result based on these changes and may provide the new analysis result to the user through the user interface 230.

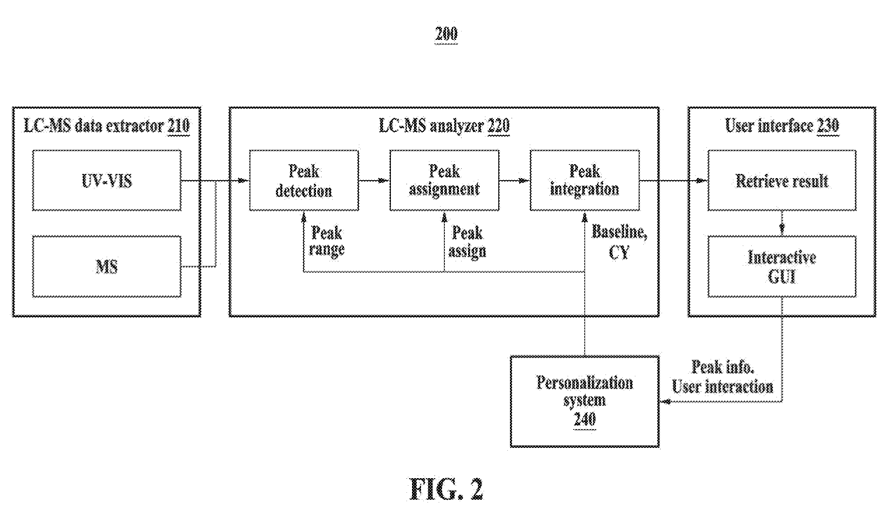

FIG. 2 is a schematic block diagram illustrating an LC-MS automation system according to one or more embodiments.

Referring to FIG. 2, one or more blocks and a combination thereof may be implemented by a special-purpose hardware-based computer that performs a predetermined function or a combination of computer instructions and special-purpose hardware.

Referring to FIG. 2, the LC-MS automation system 200 (hereinafter, the automated system 200) may include the LC-MS data extractor 210, an output device displaying the user interface 230, the LC-MS analyzer 220, and a personalization system 240.

The LC-MS data extractor 210 may output ultraviolet-visible spectroscopy (UV-VIS) data and MS data. The UV-VIS data records the absorbance of a substance over time through a chromatographic process while the MS data may indicate a mass-to-charge ratio (m/z) and ion intensity. The extracted data may be transmitted to the LC-MS analyzer 220 and may be used in major analysis processes, such as peak detection, peak assignment, and peak integration.

The LC-MS analyzer 220 may process the data received from the LC-MS extractor 210. The LC-MS analyzer 220 may perform peak detection to identify a valid peak, based on the UV-VIS data and the MS data. For example, the LC-MS analyzer 220 may extract a signal with noise being removed from the data.

The LC-MS analyzer 220 may perform peak assignment to determine whether a specific substance is included in detected peaks. For example, the detected peaks may be classified into a product, a by-product, or noise.

The LC-MS analyzer 220 may perform peak integration. For example, an analysis result may be quantified by calculating the start point, end point, or area of each peak.

The user interface 230 (e.g., a graphical user interface (GUI)) may display the analysis result to a user and may support the user to input interaction commands, such as adding, deleting, merging, or splitting peaks.

The user may check the analysis result and may modify data, if necessary, through an interactive GUI. The modified data and user input information may then be personalized by passing through the personalization system 240, and a personalized result may be transmitted to the LC-MS analyzer 220 to update the analysis result.

For example, when the user inputs a command to merge specific peaks, the LC-MS analyzer 220 may recalculate a result based on merged peak data and may display the updated result on the user interface 230.

The personalization system 240 may personalize an LC-MS analysis process based on the user input. During LC-MS data processing, a user intent and determination criteria (or metrics) may be inferred, and they may be reflected in the analysis process. The personalization system 240 may learn tasks repeatedly performed by the user and may process similar tasks in an automated manner. For example, when the user performs peak merging based on specific criteria, the personalization system 240 may update an analysis model based on this to reflect the updated analysis model in subsequent analysis.

For another example, when the LC-MS data extractor 210 generates the UV-VIS data and the MS data, the LC-MS analyzer 220 may detect peaks based on the data, may assign a specific peak as a major product, and then may calculate the area of the specific peak. The analysis result is displayed through the user interface 230, and the user may modify peaks or input additional commands as needed. An input command is stored in the personalization system 240 and may be applied automatically in a subsequent analysis process.

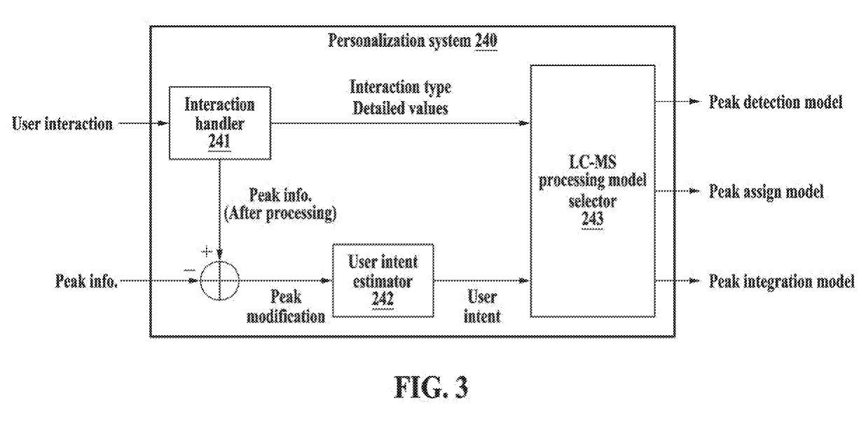

FIG. 3 is a schematic block diagram illustrating a user intent extraction and personalization system according to one or more embodiments.

Referring to FIG. 3, the personalization system 240 may include the interaction handler 241, the user intent estimator 242, and an LC-MS processing model selector 243.

The interaction handler 241 may process a user input (e.g., a user interaction) and may update peak information based on the user input to output processed peak information Peak info. (After Processing) (or also referred to as modified/changed peak information). The interaction handler 241 may receive an interaction command from the user, may modify the peak information according to the interaction command, and may calculate the modified peak information. The interaction handler 241 may process a user interaction command input involving three major steps of an analysis process: peak detection, peak assignment, and peak integration.

For a user interaction related to peak detection, the user may input a command to modify or improve data during the peak detection. For example, a user peak detection command may include a command, such as “Add Peak”, “Delete Peak”, “Modify Range”, “Merge Peaks,” or “Split Peak”. “Add Peak” may be a command to update a detected peak list by adding missing peaks from existing data. “Delete Peak” may be a command to remove incorrectly detected noise peaks. “Modify Range” may be a command to reset a peak range by adjusting the start and end points of a peak. “Merge Peaks” may be a command to merge two or more adjacent peaks into one peak. “Split Peak” may be a command to separate a merged peak into individual peaks.

For a user interaction related to peak assignment, the user may define or modify whether a detected peak corresponds to a specific substance. For example, a user peak assignment command may include a command, such as “Assign Peak as Product”, “Assign Peak as Byproduct”, or “Remove Assigned Material”. “Assign Peak as Product” may be a command to assign a specific peak as a major product. “Assign Peak as Byproduct” may be a command to assign a specific peak as a by-product. “Remove Assigned Material” may be a command to reclassify a peak by removing substance information assigned to that peak.

For a user interaction related to peak integration, the user may modify an area calculation method or a baseline during the peak integration. For example, a user peak integration command may include a command, such as “Change Baseline”. The “Change Baseline” command may update an area calculation result, such as the area under the curve corresponding to a peak and above the baseline, by modifying a baseline for a specific peak.

The interaction handler 241 may process each interaction command and may calculate the data of a peak to which an interaction command is applied and may generate processed peak information. For example, when the user inputs the command “Merge peaks 17 and 18”, the interaction handler 241 may update the information of a merged peak by recalculating the position, area, start point, and end point of the two peaks.

In addition, when a peak assignment command is input, the interaction handler 241 may check whether a specific peak is assigned as a major product or a by-product and may add or remove a data tag accordingly. When a peak integration command is input, the interaction handler 241 may change a baseline shape to adjust the area calculation result and may operate and store new data.

The user intent estimator 242 may receive the processed peak information from the interaction handler 241 and may infer a user intent by receiving original peak information. The user intent estimator 242 may interpret an interaction command performed by the user and may identify the user intent based on the interaction command. The user intent estimator 242 may compare the user input with a change in peak data and may identify which criteria and intent are applied during the analysis process.

The user intent estimator 242 may perform a comparison of data before and after user interaction to detect changes. The user intent estimator 242 may compare peak data before and after the user interaction to determine which part has been changed.

For example, when the user performs the “Merge Peaks” command, the user intent estimator 242 may detect a change by comparing data, such as the number of peaks, location, area, and height before and after merging. The changed data may be used to infer the user’s analysis criteria and may update those criteria as a personalized setting.

The user intent estimator 242 may determine which analysis process (e.g., peak detection, peak assignment, or peak integration) the changed peak information is related to. Commands, such as adding, deleting, and merging peaks, may be mainly related to peak detection. The peak assignment command may be assigning or removing a substance to a specific peak and may be related to peak assignment. The peak integration command may be mainly related to changing a baseline or calculating the area of a peak.

The user intent estimator 242 may analyze the changed data to infer metrics that define the user’s determination criteria.

For example, when the user merges two adjacent peaks, the user intent estimator 242 may analyze sub-metrics, such as distance between the two peaks, their relative heights, and their baseline gradients. This may be used to infer criteria (e.g., a relative height difference ≤ 20%) of the user merging two peaks. The metrics are defined by each user and may be applied automatically in similar situations subsequently.

The user intent estimator 242 may detect whether there has been a change in the user’s determination criteria in comparison with previous metrics.

For example, when the user changes a method for handling tailing peaks, the user intent estimator 242 may detect a change in a baseline gradient or a peak end point setting. This change may be considered an update to the user’s determination criteria and may be reflected as new metrics.

The user intent estimator 242 may learn determination criteria that is frequently used by the user in a specific peak or the analysis process and may store those determination criteria as personalized metrics.

For example, when the user sets a baseline to be horizontal at a specific peak, the user intent estimator 242 may learn that baseline and may apply the same setting automatically to similar peaks. The user may review a personalized result suggested by the personalization system 240 and may input an additional modification command if necessary.

For example, the user may perform a merging command on two adjacent peaks (e.g., the peaks 17 and 18).

The user intent estimator 242 may compare peak location, area, and height data before and after the merging and may calculate criteria (e.g., a distance between peaks and their relative heights) for merging two peaks. The user intent estimator 242 may define the user’s determination criteria as metrics and may reflect the criteria in a subsequent analysis process. Accordingly, peak merging may be performed automatically without an additional user command in the same situation.

The LC-MS processing model selector 243 (hereinafter, the model selector 243) may select the most appropriate analysis model, based on an interaction type derived from the interaction handler 241 and the user intent or intent metrics derived from the user intent estimator 242, and may apply the selected analysis model to the LC-MS analyzer 220. The model selector 243 may reflect the user criteria or may select an optimal model from among pre-trained models and apply it to LC-MS processing.

The model selector 243 may reflect a user metric-based LC-MS processing method. The model selector 243 may reflect user metrics derived through the user intent estimator 242 in the LC-MS processing method.

For example, when the user defines “relative height difference ≤ 20%” as a criterion for merging adjacent peaks, the model selector 243 may apply this metric as a configuration value of the analysis model.

Each analysis operation (e.g., peak detection, peak assignment, or peak integration) of the LC-MS analyzer 220 may be performed according to user-specified criteria. A change of the user metric-based method may be implemented only by changing a setting.

The model selector 243 may perform optimized model selection based on a validation set. The model selector 243 may select an optimal model from among a plurality of pre-trained LC-MS processing models.

For example, it may be assumed that various training networks are prepared for each analysis operation (e.g., peak detection, peak assignment, or peak integration). The model selector 243 may evaluate each model by using current LC-MS data or an additionally prepared validation set. Based on an evaluation result, the model selector 243 may select a model that accords best with the user intent and may transmit the selected model to the LC-MS analyzer 220.

For example, an optimal model may be determined by evaluating how accurately a model reflects the user metrics (e.g., e.g., a distance between peaks and their relative heights) for peak merging in the validation set.

The model selector 243 may apply a model optimized for each LC-MS processing step. The model selector 243 may apply a separately optimized model for each analysis operation.

For example, the model selector 243 may select an optimized model according to the user metrics by including noise removal, peak detection, merging, and separation, in peak detection. The model selector 243 may select a model that performs a process of assigning a target substance to a detected peak according to the user’s preferences for peak assignment. The model selector 243 may apply a model based on the user input while setting a baseline setting and calculating a peak area to peak integration.

The selected optimal model may be transmitted to an LC-MS operator and may be used in an actual analysis process. The LC-MS analyzer 220 may process data based on the transmitted model and may provide a result to the user interface 230.

For example, it may be assumed that the user assigns a specific peak as a product in LC-MS data and performs a command to merge adjacent peaks additionally. The user intent estimator 242 may analyze the user input to define the metric “relative height difference ≤ 20%”. The model selector 243 may evaluate a plurality of pre-trained models and may select a model that reflects the metric most accurately. The selected model may be transmitted to the LC-MS analyzer 220 and may generate a result personalized for the user’s demands.

FIG. 4 is a diagram illustrating LC-MS data according to one or more embodiments.

FIG. 4 shows a graph of UV data and MS data output from the LC-MS data extractor 210.

The UV data 410 records the absorbance of a sample along a time axis in LC-MS equipment and may reflect the separation of each compound. An x-axis represents time, referring to time at which a specific compound is detected while the sample moves through a chromatography column. A y-axis represents absorbance (intensity), referring to an amount of a substance detected at a specific time.

For example, the peak 17 in FIG. 4 is represented by “Product”, showing the highest absorbance. The peak 17 may represent a key time range during which a compound of interest passes through the column. Other peaks (e.g., peaks 9, 10, and 20) may be assumed to be reactants or by-products. The number assigned to a peak may vary depending on a user’s settings. A peak may be set when a peak exceeding a certain value appears during a specific time range, and numbers may be assigned to peaks appearing on the UV data 410. According to these settings, the peak 17 refers to the 17th peak among the peaks appearing on the UV data 410.

The MS data 420 is a result generated from a mass analyzer of the LC-MS equipment and may show the mass-to-charge ratio (m/z) and ion intensity of a compound separated at a specific time range. The x-axis represents a mass-to-charge ratio (m/z), which may reflect the mass characteristics of a specific compound. The y-axis represents ion intensity, which may show the relative concentration of a detected compound.

For example, in FIG. 4, the MS data 420 shows a major peak having 466.15 m/z, which may be likely a compound related to the peak 17 of the UV data 410. This mass may indicate the properties of a compound estimated to be a product. In addition, the MS data 420 may play an important role in the identification and quantitative analysis of a compound. For example, the processor 930 (see FIG. 9) may determine, based on the MS data 420, whether there are by-products or reactants, such as the peaks 9 and 10.

The UV data 410 and the MS data 420 may play complementary roles in substance analysis. The processor 930 may use the UV data 410 as the separation and quantitative information of a substance, and may use the MS data 420 to confirm the mass characteristics and chemical structure of the substance.

For example, in FIG. 4, the processor 930 may identify that the peak 17 in the UV data 410 represents the highest absorbance and is correlated to the 466.15 m/z peak in the MS data 420. This may indicate that a specific compound is present in a high concentration during that time range. Such a data correlation may be used by the processor 930 to confirm the presence of a specific substance and increase the accuracy of an analysis result.

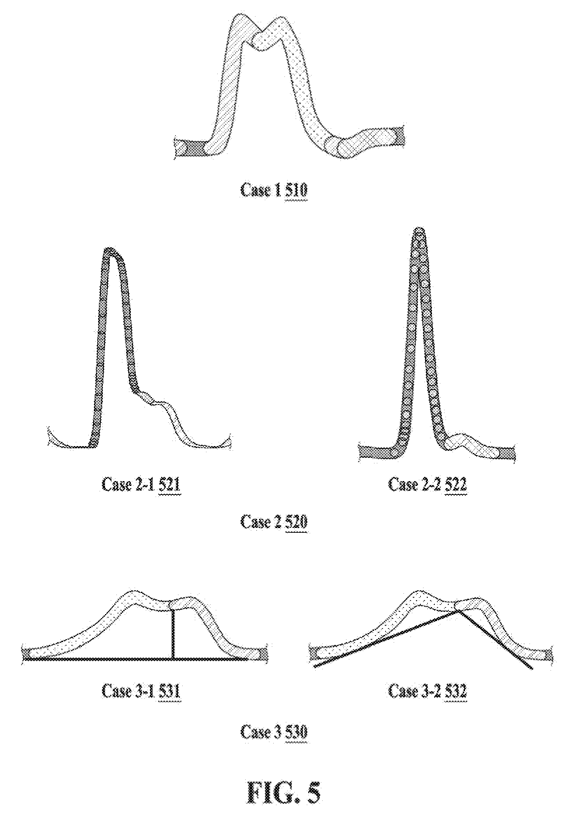

FIG. 5 is a schematic diagram illustrating an example of peak determination according to one or more embodiments.

Referring to FIG. 5, Case 1 (510) is an example of continuous peak determination, Case 2 (520) is an example of a tailing peak detected next to a major peak, and Case 3 (530) is an example of determination according to user criteria when calculating the area of a peak.

The described examples are exemplarily defined types of peak criteria that may be determined differently by each user and determinations a user has made regarding the types. Accordingly, the user’s determination criteria are not limited to the described examples.

Case 1 (510) is an exemplary diagram illustrating a process of a user determining consecutive peaks. After confirming a peak shape of Case 1 (510), the user may determine whether to merge two peaks into one peak or maintain the two peaks as two independent peaks and input the determination to the user interface 230.

Referring to Case 1 (510), the consecutive peaks are two adjacent peaks having a trough in the middle. In this case, users may make different determinations based on different pieces of information. For example, when a user 1 determines that a distance between the peaks is short, the depth of the trough is shallow, and the shapes of the two peaks are similar, the user 1 may give a command to merge the two peaks into one. When the user 1 determines to merge the two peaks into one, the automated system 200 may update peak information by recalculating the start point, end point, or area of the merged peak.

On the other hand, when a user 2 determines that the distance between the peaks is long, the depth of the trough is deep, and the respective shapes of the two peaks are independent, the user 2 may determine to maintain the two peaks as independent peaks. When the user 2 determines to maintain the two peaks as independent peaks, the automated system 200 may maintain existing peak information and may store the area and location of each peak independently.

Case 2 (520) is a diagram illustrating processing of an additional tailing peak appearing in an incomplete shape or a complete but small shape next to a major peak. In Case 2 (520), the user may determine whether to consider the additional peak as part of the major peak or separate the additional peak as an independent peak and may input the determination into the user interface 230.

The major peak is a large peak that appears in Case 2 (520), which may mainly represent the characteristics of a major component. The additional peak is an incomplete or complete peak that tails the major peak and may be assumed to be a “tailing peak”.

For example, the user may merge the additional peak into a single peak when the additional peak has a similar property to that of the major peak and does not have an independent characteristic. When the relative height and area of the additional peak is smaller than that of the major peak, and the trough is not clear, it is likely to be considered one.

Alternatively, the user may separate the additional peak as a separate peak when the additional peak has a substance property independent of that of the major peak. For example, when the relative height of the additional peak is large, the trough is distinct, or a change in a baseline is clear, it is highly likely to be determined to be an independent peak.

Case 2-1 (521) shows an additional peak connected as a tailing peak behind a major peak. In this case, the additional peak extends in the same direction as that of the major peak and may have a relatively low height. When the user considers this additional peak part of the major peak, the automated system 200 may merge the two peaks and process the two peaks as one peak, based on a user input. On the other hand, when the user considers the additional peak an independent peak, the automated system 200 may separate and process the tailing peak as a separate peak according to the user input.

Case 2-2 (522) may be an additional peak connected as another tailing peak behind the major peak. The additional peak may be adjacent to the major peak but relatively separated in shape. The user may merge or separate the major peak and the additional peak by considering the trough depth and relative height between the major peak and the additional peak. The automated system 200 may merge the major peak and the additional peak and process them as one peak or may separate them and process them as separate peaks depending on the user input.

Case 3 (530) is an example where a difference in a determination based on criteria when calculating the area of a peak varies depending on a user input. Case 3 (530) shows that an area calculation method may be applied differently according to the user’s definition in data including a plurality of peaks arranged continuously.

For example, the user may determine to separate a baseline based on a mid-point of two peaks. The user may distinguish a boundary between the peaks to emphasize the independence of each peak. Accordingly, the user may divide the area evenly based on the relative size and location between the two peaks as shown in Case 3-1 (531).

For another example, the user may determine the baseline of a peak based on a point at which the peak separates. Accordingly, the user may determine to separate peaks based on the point where the peaks are determined to be separated as shown in Case 3-2 (532) and set a line connecting the start and end points of each peak as the baseline.

Accordingly, the automated system 200 may extract a part where a result may vary depending on criteria when calculating the area of a peak based on a user intent and may provide automatic analysis based on the user’s determination.

In addition, the automated system 200, according to one or more embodiments, may analyze and extract the user intent with respect to the user’s determination criteria for MS data.

Additional case (e.g., Case 4) may be provided as a process for determining whether a specific substance is included in a specific peak. An analysis result may vary depending on user input and determination criteria.

The user may determine whether a peak includes a substance, based on an expected mass range (m/z range) of the substance to be analyzed. For example, when the expected mass range is 465-467 m/z, and a detection value of that peak falls within this range, the user may determine that the substance is present.

The user may analyze the peak by considering whether the substance has gone through ionization, such as protonation. For example, when the substance is +1 ionized, its expected mass may be determined to be 466 m/z, increased by 1.

The user may evaluate the presence of a substance, based on the hit count of the substance having a corresponding mass. For example, when the hit count of a target substance for a specific peak is 5 or more, it may be determined that the target substance exists.

The user may determine that the target substance is present when a ratio of the target substance to the peak is high enough, compared to surrounding noise or by-products. For example, the target substance may be considered present if it accounts for more than 60% of the total signal at the peak.

The user may determine the presence of a substance for the same peak by considering time delay between a UV detector and an MS detector. For example, when a peak of UV data matches a peak of MS data within a time error of ±0.1 minutes, the peaks may include the same substance.

With respect to what is determined by the user as described above, when the user determines the presence of a substance for a specific peak or performs assignment, the interaction handler 241 may process a corresponding command and update peak information. For example, when the user assigns the specific peak to the target substance or removes an incorrect assignment, the interaction handler 241 may generate modified peak information accordingly.

In addition, the user intent estimator 242 may compare peak information before and after its modification to identify criteria for determining the presence of a substance set by the user and define the criteria as metrics. For example, when the user changes a reference hit count for the target substance at a peak fromb to 5, the user intent estimator 242 may reflect the changed reference hit count and set new determination criteria. In addition, when the user sets to consider protonation additionally, the metrics may be updated accordingly to reflect it in analysis.

Based on the determination criteria and metrics defined by the user, the LC-MS processing model selector 243 may select an optimal model related to peak assignment and apply the selected model to the analysis process. For example, the model selector 243 may select a model that determines the presence of a substance based on a noise ratio for a specific peak.

For example, when the user sets to determine the presence of a substance based on an expected mass range and a hit count at a specific peak, the automated system 200 may process it to update peak information. When the user sets to take protonation into account, the automated system 200 may reflect the new criteria by adding protonation to a mass range of the target substance. When there is a command to remove peaks whose noise ratio is less than or equal to a certain percentage (e.g., 40%), the automated system 200 may filter peak information based on this command.

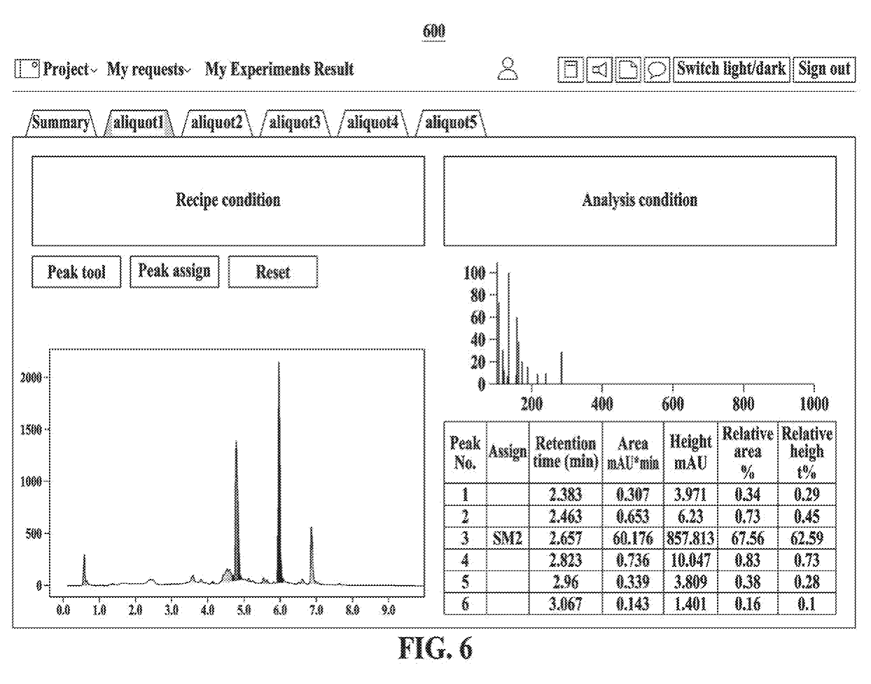

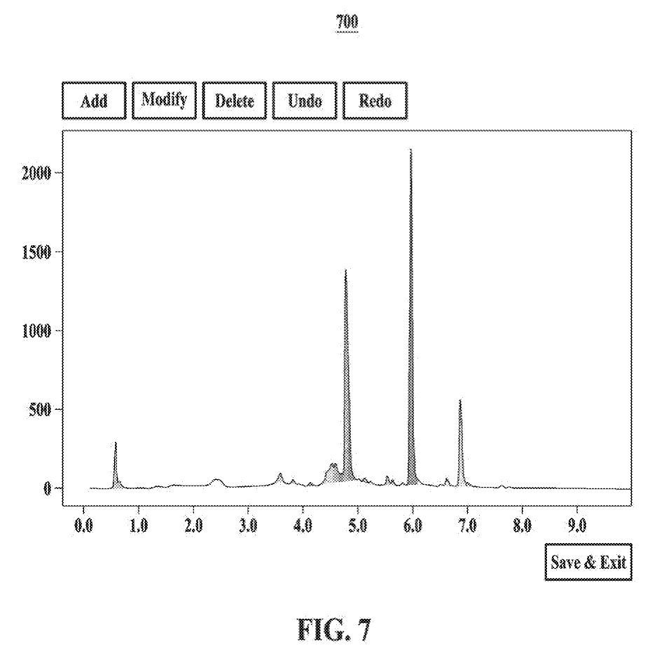

FIGS. 6 and 7 are exemplary diagrams illustrating a user interface according to one or more embodiments.

Referring to FIG. 6, in a user interface 600 (e.g., the user interface 200 of FIG. 2), “Recipe Condition” and “Analysis Condition” interfaces may provide analysis conditions and setting information to a user. “Recipe Condition” may be an interface that represents conditions set for a sample, and “Analysis Condition” may be an interface that represents conditions used during LC-MS analysis.

“Peak Tool”, “Peak Assign”, and “Reset” interfaces may be an interface that provides the user with a tool for a specific peak, an interface that provides a tool for assignment to the specific peak, or an interface for resetting a result.

The user interface 600 may visualize an LC-MS analysis result as a graph and may provide the user with the location, height, or area of a peak. Each peak is distinguished by colors, and a major peak may be labeled.

In addition, the user interface 600 may provide the detailed information on each peak in a table. The table may include a peak number, an assignment state (Assign), a retention time (Retention Time), an area (Area), a height (Height), a relative area, and a relative height.

Referring to FIG. 7, “Add”, “Modify”, “Delete”, “Undo”, and “Redo” interfaces in an edit interface 700 may be interfaces that receive commands from the user to add, modify, or delete a peak or undo or redo a task. For example, the user may separate peaks having merged incorrectly or adjust the location of a specific peak to generate more accurate data through the edit interface 700.

The edit interface 700 visualizes an LC-MS analysis result as a graph and may provide it for the user to intuitively edit the location and characteristics of a peak. For example, the user may delete a peak detected incorrectly or modify two peaks that need to be merged. The user may define a new peak manually by adding a specific peak. These command inputs of the user may be reflected in the analysis result graph in real time, and the automated system 200 may extract a user intent based on the graph result after the reflection to select or update an analysis model.

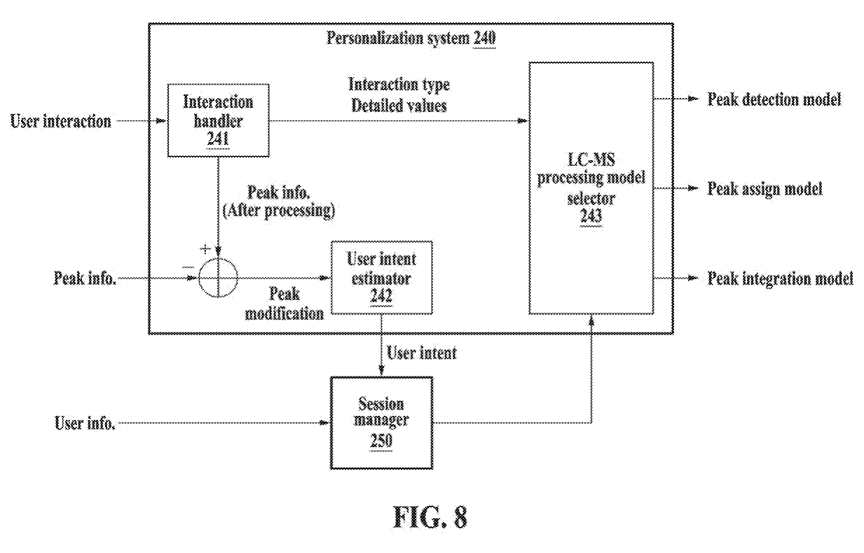

FIG. 8 is a block diagram schematically illustrating a personalization system including a session manager according to one or more embodiments.

The description provided with reference to FIGS. 1 to 7 may also apply to FIG. 8, and any repeated description thereof is omitted.

Referring to FIG. 8, the personalization system 240 may further include a session manager 250. The session manager 250 may deliver a personalized record to the model selector 243 based on user information and a user intent extracted from the user intent estimator 242. The session manager 250 may systematically store and manage information on a user’s interaction and analysis process. The session manager 250 maintains a personalized record for each user such that a personalized setting may be provided automatically to the user during a subsequent analysis process.

The session manager 250 may record interactions performed by the user. For example, operations, such as the assignment, merging, and deletion of a specific peak, may be stored in the session manager 250. When the user changes their intent or selects a new analysis method, the session manager 250 may learn and record it.

The personalization system 240 may update the analysis process based on the user’s record through the session manager 250. For example, the personalization system 240 may automatically apply a model and analysis setting selected by the user in a previous session. The personalization system 240 may learn the user’s preferences by analyzing recorded data and may recommend a processing model suitable for subsequent analysis.

The personalization system 240 may receive the user’s analysis history through the session manager 250 and may provide an individually customized result. For example, when a specific noise removal or peak integration method is used consistently, the personalization system 240 may set that method as a default. In addition, the session manager 250 may support the user to retrieve a previously analyzed result in the personalization system 240 and continue working thereon.

FIG. 9 is a block diagram illustrating an electronic device according to one or more embodiments.

The description provided with reference to FIGS. 1 to 8 may also apply to FIG. 9, and any repeated description thereof is omitted.

Referring to FIG. 9, an electronic device 900 may include a processor 930, a memory 950, and an output device 970 (e.g., a display). The processor 930, the memory 950, and the output device 970 may be connected to one another via a communication bus 905. The electronic device 900 may include the processor 930 for performing the at least one method described above or an algorithm corresponding to the at least one method, for operating the electronic device 900.

The output device 970 may display a user interface for an LC-MS automation method through the processor 930. The output device 970 may be the same device as a display included in the electronic device 900. In addition, the output device 970 may be embedded in the electronic device 900 to display the user interface or may be an external display device.

The memory 950 may store pieces of data related to the LC-MS automation method performed by the processor 930. Further, the memory 950 may store various pieces of information generated in the processing of the processor 930 described above. In addition, the memory 950 may store various pieces of data and programs. The memory 950 may include, for example, a volatile memory or a non-volatile memory. The memory 950 may include a high-capacity storage medium, such as a hard disk, to store various pieces of data.

In addition, the processor 930 may perform at least one method described with reference to FIGS. 1 to 8 or an algorithm corresponding to the at least one method. In the above-described process, the processor 930 may be a hardware-implemented data processing device having a circuit that is physically structured to execute desired operations. The desired operations may include, for example, codes or instructions included in a program. The processor 930 may be implemented as, for example, a central processing unit (CPU), a graphics processing unit (GPU), or a neural network processing unit (NPU). For example, a hardware-implemented electronic device 900 may include, for example, a microprocessor, a CPU, a processor core, a multi-core processor, a multiprocessor, an application-specific integrated circuit (ASIC), and a field programmable gate array (FPGA).

The processor 930 may execute a program and control the electronic device 900. Program code to be executed by the processor 930 may be stored in the memory 950.

The examples described herein may be implemented by using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or combinations thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved when the described techniques are performed in a different order, and/or if components in a described system, architecture, device, or circuit are combined in a different manner, and/or replaced or supplemented by other components or their equivalents.

Therefore, other implementations, other examples, and equivalents to the claims are also within the scope of the following claims.

What is claimed is:

1. A method of automating spectrometry, the method comprising:
obtaining an analysis result by performing an analysis process on spectrometry data;
displaying the analysis result on a user interface and receiving a user input through the user interface;
identifying at least one of a user intent or an analysis criterion based on the user input; and
performing an update to the analysis process based on the at least one of the user intent or the analysis criterion.

2. The method of claim 1, further comprising providing a personalized result to a user based on the updated analysis process.

3. The method of claim 1, wherein the obtaining of the analysis result comprises performing at least one of peak detection, peak assignment, and peak integration, based on the spectrometry data.

4. The method of claim 1, wherein the user interface is configured to display an interface for peak modification.

5. The method of claim 1, wherein the identifying of the at least one of the user intent or the analysis criterion comprises:
inferring how a user determines a peak shape.

6. The method of claim 1, wherein the identifying of the at least one of the user intent and the analysis criterion comprises:
selecting a spectrometry analysis model or updating the spectrometry analysis model.

7. The method of claim 6, further comprising:
processing peak information in response to on a user’s interaction command for at least one of peak detection, peak assignment, and peak integration.

8. The method of claim 6, further comprising:
analyzing a pattern of a change by comparing data before and after a peak modification in response to the user input.

9. The method of claim 3, wherein the peak detection comprises detecting a valid peak from the spectrometry data.

10. The method of claim 3, wherein the peak assignment comprises determining whether there is a target substance for a detected peak.

11. The method of claim 3, wherein the peak integration comprises operating information on each of detected peaks.

12. The method of claim 1, wherein the identifying of the at least one of the user intent and the analysis criterion comprises:
obtaining a personalized record based on a history management of the user input and information of a user.

13. A non-transitory computer-readable storage medium storing instructions that, when executed by a processor, cause the processor to perform the method of claim 1.

14. An electronic device comprising:
one or more processors,
wherein instructions, when performed by the one or more processors, cause the electronic device to
obtain an analysis result by performing an analysis process on spectrometry data,
display the analysis result on a user interface and receive a user input through the user interface,
identify at least one of a user intent or an analysis criterion based on the user input, and
perform an update to the analysis process based on the at least one of the user intent or the analysis criterion.

15. The electronic device of claim 14, wherein the instructions, when performed by the one or more processors, cause the electronic device to provide a personalized result to a user based on the updated analysis process.

16. The electronic device of claim 14, wherein the instructions, when performed by the one or more processors, cause the electronic device to perform at least one of peak detection, peak assignment, or peak integration on the spectrometry data.

17. The electronic device of claim 14, wherein the user interface is configured to display an interface for peak modification.

18. The electronic device of claim 14, wherein the instructions, when performed by the one or more processors, cause the electronic device to infer how a user determines a peak shape.

19. The electronic device of claim 14, wherein the instructions, when performed by the one or more processors, cause the electronic device to select an spectrometry analysis model or update the spectrometry analysis model.

20. A system of automating spectrometry, the system comprising:
a processor configure to:
obtain spectrometry data;
obtain an analysis result by performing an analysis process on the spectrometry data;
a user interface configured to display the analysis result and receive a user input; and
wherein the processor is further configured to:
identify at least one of a user intent and an analysis criterion based on the user input; and
perform an update to the analysis process based on the at least one of the user intent and the analysis criterion.
